(19) United States
(12) Patent Application Publication
(10) Pub. No.: US 2008/0239635 A1
(43) Pub. Date: Oct. 2, 2008

(54) Notebook computer hinge

(75) Inventor: Po-Chuan Chen, Shulin City (TW)

Correspondence Address: JACKSON WALKER, L.L.P., 112 E. PECAN, SUITE 2400, SAN ANTONIO, TX, 78205, US

(73) Assignee: Shin Zu Shing Co., Ltd.

(21) Appl. No.: 11/729,683

(22) Filed: Mar. 29, 2007

(51) Int. Cl. G06F 1/16; E05F 1/12

(52) U.S. Cl. 361/681

(57) ABSTRACT

A notebook computer hinge has a screen tab, a main tab, a pintle for connecting the screen tab with the main tab pivotally. A support tab has a hole for the pintle. A longitudinal hole is defined through the support tab and is engaged with a connecting piece on the screen tab. A first stop is C-shaped is formed on the pintle between the support tab and the main tab and has a gap. The support tab has a second stop formed on the support tab and engaged with the gap. Thus the screen is limited to pivot in a specific angular extent.

### BACKGROUND OF THE INVENTION

1. Field of the Invention

The present invention relates to a notebook computer hinge, and particularly relates to a notebook computer hinge that is used for avoiding the sway of a screen on a notebook computer and limiting the screen to pivot in a specific angular extent.

2. Description of the Related Art

The notebook computer is popular recently, which is excellent in small size and portable characteristics. Because the pivot point is far from the free end of the screen, the screen is easy to sway, which is harmful to the hinge.

An improved hinge for a notebook computer prevents the screen from swaying. However, the improved hinge does not limit the screen to pivot in a specific angular extent.

Therefore, the invention provides a notebook computer hinge to mitigate or obviate the aforementioned problems.

### SUMMARY OF THE INVENTION

The main objective of the present invention is to provide a notebook computer hinge that keeps a screen on a notebook computer from swaying and limits the screen to pivots in a specific angular extent.

A notebook computer hinge in accordance with the present invention comprises a screen, a main tab, a pintle and a support tab.

The screen tab is connected with a screen of a notebook computer. A tubular portion is formed on the screen tab, and a connecting piece provided between the screen tab and the tubular portion.

The main tab is connected with a main body of the notebook computer and has a proximal end and a recess defined in the proximal end.

a pintle is mounted rotatably in the tubular portion and has two ends and a shaft protruding from one end and mounted secured in the recess of the main tab.

The support tab is mounted on the connecting piece and has a hole defined through the support tab so the pintle is mounted through the hole. A longitudinal hole is defined through the support tab above the hole and is engaged with the connecting piece.

A first stop is C-shaped and is formed radially on the pintle between the support tab and the main tab and has a gap. The support tab has a second stop formed on the support tab and engaged with the gap.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the notebook computer hinge in accordance with this invention;

FIG. 2 is an exploded perspective view of the notebook computer hinge in FIG. 1;

FIG. 3 is a side view of the notebook computer hinge in FIG. 1; and

FIG. 4 is an operational side view of the notebook computer hinge in FIG. 3 pivoting up away from the main tab.

### DETAILED DESCRIPTION OF THE PREFERRED EMBODIMENT

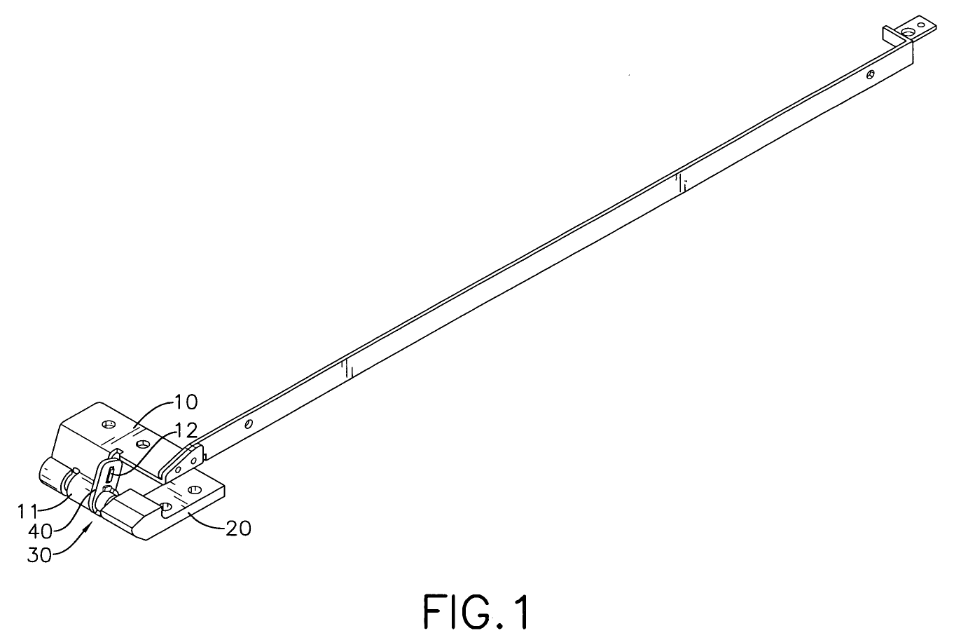

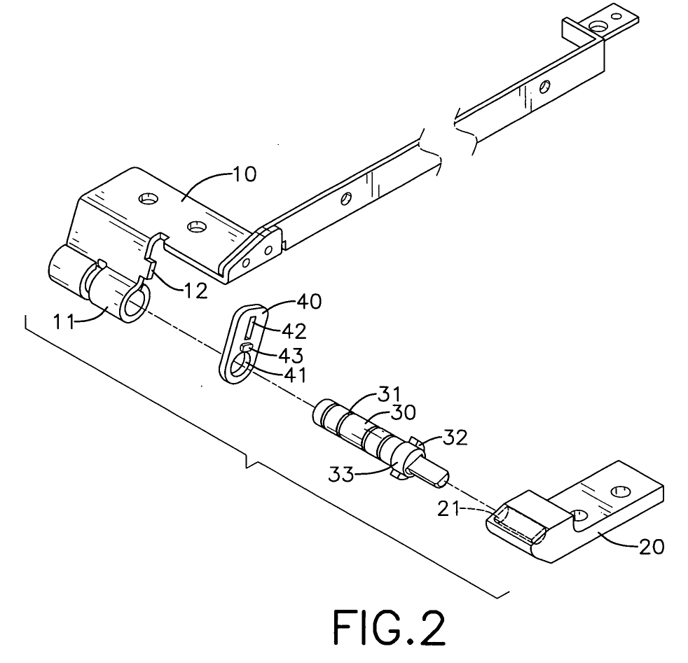

With reference to FIGS. 1-2, a notebook computer hinge has a screen tab (10) connected with a screen of a notebook computer. A tubular portion (11) is formed on the screen tab (10). A connecting piece (12) is formed on and located between the screen tab (10) and the tubular portion (11). A main tab (20) is connected with a main body of the notebook computer and has a proximal end and a semi-circular recess (21) defined in the proximal end. A pintle (30) is mounted rotatably in the tubular portion (11) and has two ends, a semi-circular shaft and multiple lubricant grooves (31). The semi-circular shaft is formed on and protrudes from one end of the pintle (30) and is mounted securely in the semi-circular recess (21). Thus the main tab (20) and the screen tab (10) are pivotally connected by the pintle (30). The lubricant grooves (31) are defined radially in the pintle (30). A support tab (40) is mounted on the connecting piece (12) and has a hole (41) defined through the support tab (40) so that the pintle (30) is mounted tightly through the hole (41) to prevent the screen on from inadvertently swaying on the notebook computer. A longitudinal hole (42) is defined through the support tab (40) above the hole (41) and is engaged with the connecting piece (12).

A first stop (32) is C-shaped, is formed on and protrudes radially from the pintle (30) between the support tab (40) and the main tab (20) and has a gap (33) defined radially in the first stop (32) and having two inside ends. The support tab (40) has a second stop (43) formed on the support tab (40) and engaged with the gap (33) so that the second stop (43) is able to move in the gap (33) of the first stop (32).

The connecting piece (12) of the screen tab (10) is engaged with the longitudinal hole (42) in the support tab (40) by riveting.

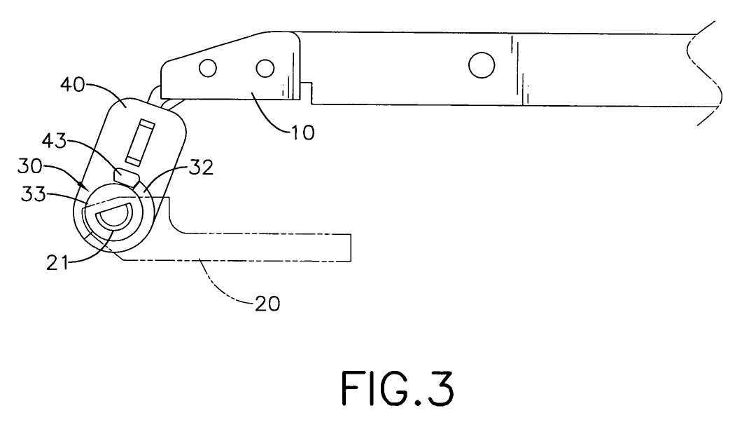

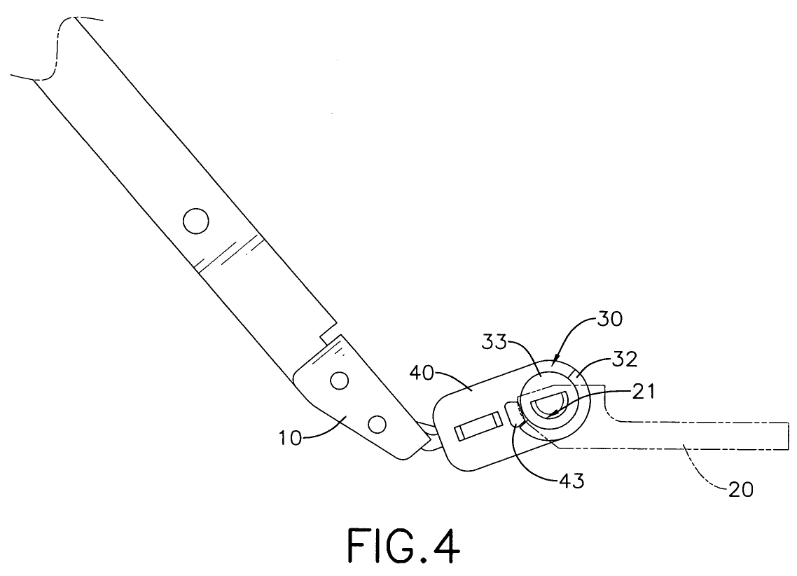

With reference to FIG. 3, when the screen is closed on the main body, the screen tab (10) moves closely to the main tab (20), meanwhile, the second stop (43) presses against one inside end of the gap (33), as shown in FIG. 4. When the screen is opened and pivoted away from the main body, the screen tab (10) moves away from the main tab (20), until the second stop (43) presses against the other inside end of the gap (33). Thus the screen is limited to pivot in a specific angular extent.

The support tab (40) mounted tightly on the pintle and engaged with the connecting piece (12) prevent the screen from inadvertently swaying so that a user would not have to adjust the screen frequently to hold the screen. Furthermore, the first and second stops (32, 43) limit the screen to pivot in the specific angular extent so the screen would not pivot excessively to damage the circuit between the screen and the main body.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A notebook computer hinge comprising:
a screen tab adapted to be connected with a screen of a notebook computer, a tubular portion formed on the screen tab, and a connecting piece formed on and located between the screen tab and the tubular portion;
a main tab adapted to be connected with a main body of the notebook computer and having a proximal end and a recess defined in the proximal end;
a pintle mounted rotatably in the tubular portion and having two ends and a shaft formed on and protruding from one end of the pintle and mounted securely in the recess of the main tab; and
a support tab mounted on the connecting piece and having a hole defined through the support tab and through which the pintle is mounted, a longitudinal hole defined through the support tab above the hole and engaged with the connecting piece;
wherein a first stop is C-shaped, is formed on and protrudes radially from the pintle between the support tab and the main tab and has a gap defined radially in the first stop and having two ends, the support tab has a second stop formed on the support tab and engaged with the gap.

2. The notebook computer hinge as claimed in claim 1, wherein the recess defined in the main tab is semi-circular.

3. The notebook computer hinge as claimed in claim 1, wherein multiple lubricant grooves are defined radially in the pintle.
